(19) United States
(12) Patent Application Publication
(10) Pub. No.: US 2026/0192286 A1
(43) Pub. Date: Jul. 9, 2026

(54) FINISHING HYDRODESULFURIZATION CATALYST COMPRISING A GROUP VIB METAL, A GROUP VIII METAL AND PHOSPHORUS ON AN ALPHA ALUMINA SUPPORT

(71) Applicant: IFP Energies Nouvelles, Rueil-Malmaison (FR)

(72) Inventors: Marie DEHLINGER, Rueil-Malmaison Cedex (FR); Alexandre VONNER, Rueil-Malmaison Cedex (FR); Charlie BLONS, Rueil-Malmaison Cedex (FR); Antoine FECANT, Rueil-Malmaison Cedex (FR)

(73) Assignee: IFP Energies Nouvelles, Rueil-Malmaison (FR)

(21) Appl. No.: 19/131,697

(22) PCT Filed: Nov. 23, 2023
(86) PCT No.: PCT/EP2023/082854

§ 371 Date: May 21, 2025

(30) Foreign Application Priority Data
Nov. 30, 2022 (FR) FR2212555

(51) Int. Cl. B01J 27/19; B01J 21/04; B01J 35/31; B01J 35/40; B01J 35/51; B01J 35/61; B01J 35/63; C10G 45/08

(52) U.S. Cl. CPC B01J 27/19; B01J 21/04; B01J 35/31; B01J 35/40; B01J 35/51; B01J 35/612; B01J 35/613; B01J 35/615; B01J 35/635; C10G 45/08; C10G 2300/1037; C10G 2300/70; C10G 2400/02

(57) ABSTRACT

A polishing hydrodesulfurization catalyst comprising an active phase comprising at least one group VIB metal and at least one group VIII metal, phosphorus, and a porous support comprising alpha-alumina, the content of group VIB metal, measured in oxide form, being between 1% and 8% by weight relative to the total weight of the catalyst, the content of group VIII metal, measured in oxide form, being between 0.2% and 5% by weight relative to the total weight of the catalyst, and the content of phosphorus, measured in its P₂O₅ form, being between 0.1% and 3% by weight relative to the total weight of the catalyst, said catalyst having a specific surface area of greater than or equal to 1 m²/g and less than 20 m²/g. The catalyst of one example contains the oxides of Co, Mo and P on alpha-alumina.

### FIELD OF THE INVENTION

The present invention relates to the field of hydrotreating gasoline cuts, notably gasoline cuts resulting from fluidized-bed catalytic cracking units. More particularly, the present invention relates to the use of catalysts in a process for producing low-sulfur gasoline. The invention applies very particularly to the treatment of gasoline cuts containing olefins and sulfur, such as gasolines resulting from catalytic cracking, for which it is desired to reduce the content of sulfur compounds, without hydrogenating the olefins and the aromatics.

### PRIOR ART

Automotive fuel specifications require a significant reduction in the sulfur content in these fuels, and notably in gasolines. This reduction is notably directed toward limiting the content of sulfur and nitrogen oxides in motor vehicle exhaust gases. The specifications currently in force in Europe since 2009 for gasoline fuels set a maximum content of 10 ppm (parts per million) by weight of sulfur. Such specifications are also in force in other countries, for instance the United States and China, where the same maximum sulfur content has been required since January 2017. To achieve these specifications, it is necessary to treat gasolines via desulfurization processes.

The main sources of sulfur in gasoline bases are “cracked” gasolines, and mainly the gasoline fraction obtained from a process of catalytic cracking of a vacuum distillate or of an atmospheric or vacuum distillation residue of a crude oil. The gasoline fraction from catalytic cracking, which represents on average 40% of gasoline bases, in fact accounts for more than 90% of the sulfur in gasolines. Consequently, the production of low-sulfur gasolines requires a step of desulfurization of the catalytic cracking gasolines. Among the other sources of gasolines that may contain sulfur, mention may also be made of coker gasolines, visbreaker gasolines or, to a lesser extent, gasolines obtained from atmospheric distillation or steam cracking gasolines. The removal of sulfur from gasoline cuts consists in specifically treating these sulfur-rich gasolines via desulfurization processes in the presence of hydrogen. These are then referred to as hydrodesulfurization (HDS) processes. However, these gasoline cuts, and more particularly the fluid catalytic cracking (FCC) gasolines, contain a large proportion of unsaturated compounds in the form of monoolefins (about 20% to 50% by weight) which contribute toward a good octane number, diolefins (0.5% to 5% by weight) and aromatics. These unsaturated compounds are unstable and react during the hydrodesulfurization treatment. Diolefins form gums by polymerization during the hydrodesulfurization treatments.

This gum formation leads to gradual deactivation of the hydrodesulfurization catalysts or gradual clogging of the reactor. Consequently, the diolefins must be removed by hydrogenation before any treatment of these gasolines. Conventional treatment processes desulfurize gasolines non-selectively by hydrogenating a large portion of the monoolefins, giving rise to a high loss of octane number and high hydrogen consumption. The most recent hydrodesulfurization processes make it possible to desulfurize cracked gasolines rich in monoolefins, while at the same time limiting the hydrogenation of the monoolefins and consequently the loss of octane. Such processes are described, for example, in documents EP-A-1077247 and EP-A-1174485.

However, when very thorough desulfurization of cracked gasolines needs to be performed, some of the olefins present in the cracked gasolines are hydrogenated, on the one hand, and recombine with H₂S to form mercaptans, on the other hand. This family of compounds, of chemical formula R—SH where R is an alkyl group, are generally called recombinant mercaptans, and generally represent between 20% by weight and 80% by weight of the residual sulfur in desulfurized gasolines. Reduction of the content of recombinant mercaptans may be achieved by catalytic hydrodesulfurization, but this leads to the hydrogenation of a large portion of the monoolefins present in the gasoline, which then leads to a large reduction in the octane number of the gasoline and also to an overconsumption of hydrogen. It is moreover known that the loss of octane due to the hydrogenation of the monoolefins during the hydrodesulfurization step is proportionately greater the lower the targeted sulfur content, i.e. when it is sought to thoroughly remove the sulfur compounds present in the feedstock.

It is thus possible to treat the gasoline by a sequence of two reactors as described in document EP 1 077 247; the aim of the first step, also called the selective HDS step, is generally to carry out a deep desulfurization of the gasoline with minimal olefin saturation (and no aromatic loss), resulting in a maximum octane retention. The catalyst employed is generally a catalyst of CoMo type. During this step, new sulfur compounds are formed by recombination of the H₂S resulting from the desulfurization and the olefins: recombinant mercaptans.

The second step generally has the role of minimizing the amount of recombinant mercaptans. The temperature is generally higher in the second step in order to thermodynamically promote the removal of the mercaptans. In practice, a furnace is thus placed between the two reactors in order to be able to raise the temperature of the second reactor to a temperature greater than that of the first.

The catalyst used in the polishing process must be particularly selective so as not to induce olefin saturation (and no aromatic loss) resulting in a loss of octane. It must therefore make it possible to reduce the contents of total sulfur and of mercaptans in hydrocarbon cuts, preferably in gasoline cuts, to very low contents, while minimizing the reduction in the octane number. Usually, the catalyst used is based on nickel.

It is known from patent FR 3,023,184 to provide a hydrotreating catalyst on an alumina-based support comprising at least a group VIB metal, a group VIII metal and phosphorus, having a specific surface area of between 20 and 150 m²/g and a high density of group VIB metal per unit area of the catalyst of between 7 and 30 metal atoms per nm² of catalyst.

It is also known from patent FR 2,840,315 to provide the use of a catalyst comprising at least a group VIB metal, a group VIII metal and a support having a specific surface area of less than 200 m²/g wherein the density of group VIB metal per unit area of the support is between 4×10⁻⁴ and 36×10⁻⁴ g of group VIB metal oxides per m² of support.

However, there is still a need to maximize performance in hydrotreating gasoline cuts in order to achieve the sulfur specifications.

Surprisingly, the applicant has discovered that a catalyst based on at least one group VIII metal, at least one group VIB metal and phosphorus on an alpha-alumina support makes it possible to improve gasoline hydrotreating performance when this hydrotreating is carried out in a polishing hydrodesulfurization section (FNS) located downstream of the selective hydrodesulfurization section (HDS). Without being bound to any theory, the use of such a catalyst in the polishing hydrodesulfurization section makes it possible to remove some of the refractory sulfur compounds in the polishing section while retaining the olefins which is induced by a high selectivity enabled by a specific interaction between the active phase and the surface of the alpha-alumina support.

### Subjects of the Invention

The present invention relates to a polishing hydrodesulfurization catalyst comprising an active phase containing at least one group VIB metal and at least one group VIII metal, phosphorus, and a porous support comprising alpha-alumina. The content of group VIB metal, measured in oxide form, is between 1% and 8% by weight relative to the total weight of the catalyst, the content of group VIII metal, measured in oxide form, is between 0.2% and 5% by weight relative to the total weight of the catalyst, and the content of phosphorus, measured in its P₂O₅ form, is between 0.1% and 3% by weight relative to the total weight of the catalyst, said catalyst a specific surface area of greater than or equal to 1 m²/g and less than 20 m²/g.

According to one or more embodiments, the molar ratio of the group VIII metal to the group VIB metal is between 0.1 and 2.0 mol/mol.

According to one or more embodiments, the molar ratio of the phosphorus to the group VIB metal is between 0.1 and 2.0 mol/mol.

According to one or more embodiments, the specific surface area of the catalyst is between 1 and 16 m²/g.

According to one or more embodiments, the surface density of group VIB metal, expressed as the weight of group VIB metal oxides per unit area of the catalyst, is between 33×10⁻⁴ and 130×10⁻⁴ g/m².

According to one or more embodiments, the group VIII metal is cobalt and the group VIB metal is molybdenum.

According to one or more embodiments, the support is in the form of beads.

According to one or more embodiments, said catalyst comprises an active phase consisting of molybdenum and cobalt, phosphorus, and a porous support consisting of alpha-alumina, the cobalt content being between 0.5% and 3% by weight, measured in the CoO oxide form, relative to the total weight of the catalyst, the molybdenum content being between 3% and 7% by weight, measured in the MoO₃ oxide form, relative to the total weight of the catalyst, a phosphorus content of between 0.3% and 1.5% by weight, measured in the P₂O₅ oxide form, relative to the total weight of the catalyst, the molar ratio of cobalt to molybdenum being between 0.3 and 1.0 mol/mol, the molar ratio of phosphorus to molybdenum being between 0.2 and 0.5 mol/mol, the surface density of molybdenum, expressed in the MoO₃ oxide form, being between 40×10⁻⁴ and 90×10⁻⁴ g/m², the specific surface area of the catalyst being between 1 and 16 m²/g.

Another subject of the invention relates to a process for treating a gasoline containing sulfur compounds and olefins, the process comprising at least the following steps:
a) the gasoline, hydrogen and a hydrodesulfurization catalyst comprising an active phase comprising a group VIB metal and a group Vill metal at least partly in sulfide form, and an oxide support, are brought into contact in a first reaction section at a temperature of between 200° C. and 350° C., at a pressure of between 0.2 MPa and 5 MPa, with an hourly space velocity of between 1 h⁻¹ and 20 h⁻¹ and a ratio of the hydrogen flow rate, expressed in normal m³ per hour, to the flow rate of feedstock to be treated, expressed in m³ per hour under standard conditions, of between 10 Nm³/m³ and 1000 Nm³/m³, in order to obtain a partially desulfurized effluent;
b) without separating the H₂S formed in step a), the partially desulfurized effluent obtained on conclusion of step a), and a polishing hydrodesulfurization catalyst according to the invention at least partly in sulfide form, are brought directly into contact in a second reaction section at a temperature of between 250° C. and 400° C., at a pressure of between 0.2 MPa and 5 MPa, with an hourly space velocity of between 1 h⁻¹ and 20 h⁻¹, in order to obtain a desulfurized effluent.

According to one or more embodiments, the temperature of step b) is higher than the temperature of step a).

According to one or more embodiments, the gasoline is a catalytic cracking gasoline.

### DETAILED DESCRIPTION

### Definitions

In the text hereinbelow, the groups of chemical elements are given according to the CAS classification (CRC Handbook of Chemistry and Physics, published by CRC Press, editor-in-chief D. R. Lide, 81st edition, 2000-2001). For example, group VIII (or VIIIB) according to the CAS classification corresponds to the metals of columns 8, 9 and 10 according to the new IUPAC classification.

The BET specific surface area is measured by nitrogen physisorption according to the standard ASTM D3663-03, a method described in the work by Rouquerol F., Rouquerol J. and Singh K., “Adsorption by Powders & Porous Solids: Principles, Methodology and Applications”, Academic Press, 1999.

In the following description of the invention, the “total pore volume” of the oxide support or of the catalyst is understood to mean the volume measured by mercury porosimetry according to the standard ASTM D4284-83 at a maximum pressure of 4000 bar (400 MPa), using a surface tension of 484 dyne/cm and a contact angle of 140°. The wetting angle was taken equal to 140° following the recommendations of the publication “Techniques de l′ingénieur, traité analyse et caractérisation” [Techniques of the Engineer, Analysis and Characterization Treatise], pages 1050-5, written by Jean Charpin and Bernard Rasneur.

In order to obtain better accuracy, the value of the total pore volume in ml/g or in cm³/g given in the following text corresponds to the value of the total mercury volume (total pore volume measured by intrusion with a mercury porosimeter) in ml/g or in cm³/g measured on the sample minus the mercury volume value in ml/g or in cm³/g measured on the same sample for a pressure corresponding to 30 psi (approximately 0.2 MPa).

The contents of group VIII metal, of group VIB metal and of phosphorus are measured by X-ray fluorescence.

The contents of group VIB metal, of group VIII metal and of phosphorus in the catalyst are expressed as oxides after correction for the loss on ignition of the catalyst sample at 550° C. in a muffle furnace for two hours. The loss on ignition is due to the loss of moisture. It is determined according to ASTM D7348.

### Polishing Hydrodesulfurization Catalyst

The catalyst according to the invention comprises, preferably consists of, an active phase comprising at least one group VIB metal and at least one group VIII metal, phosphorus, and a porous support comprising, preferably consisting of, alpha-alumina, the content of group VIB metal, measured in oxide form, being between 1% and 8% by weight relative to the total weight of the catalyst, the content of group VIII metal, measured in oxide form, being between 0.2% and 5% by weight relative to the total weight of the catalyst, and the content of phosphorus, measured in its P₂O₅ oxide form, being between 0.1% and 3% by weight relative to the total weight of the catalyst, said catalyst having a specific surface area of greater than or equal to 1 m²/g and less than 20 m²/g.

The content of group VIB metal in the active phase, measured in oxide form, is between 1% and 8% by weight, relative to the total weight of the catalyst, preferably between 2% and 7% by weight and even more preferentially between 3% and 7% by weight. The group VIB metal is preferably molybdenum. When the metal is molybdenum, the metal content is expressed as MoO₃.

The content of group VIII metal in the active phase, measured in oxide form, is between 0.2% and 5% by weight, relative to the total weight of the catalyst, preferably between 0.5% and 4% by weight and even more preferentially between 0.5% and 3% by weight. The group VIII metal is preferably cobalt. When the metal is cobalt, the content of cobalt is expressed as CoO.

The content of phosphorus, measured in its P₂O₅ oxide form, is between 0.1% and 3% by weight relative to the total weight of the catalyst, preferably between 0.2% and 2% by weight, and even more preferentially between 0.3% and 1.5% by weight.

Preferably, the molar ratio of the group VIII metal of the active phase to the group VIB element of the active phase is between 0.1 and 2.0 mol/mol, preferably between 0.3 and 1.0 mol/mol.

Preferably, the molar ratio of the phosphorus to the group VIB metal of the active phase is between 0.1 and 2.0 mol/mol, preferably between 0.2 and 1.0 mol/mol, more preferentially between 0.2 and 0.5 mol/mol.

The specific surface area of the catalyst is greater than or equal to 1 m²/g and less than 20 m²/g, preferably between 1 m²/g and 16 m²/g, and even more preferentially between 5 m²/g and 15 m²/g.

The catalyst advantageously has a total pore volume, measured by mercury porosimetry, of between 0.3 cm³/g and 0.9 cm³/g, preferably between 0.35 cm³/g and 0.8 cm³/g, and very preferably between 0.4 cm³/g and 0.7 cm³/g.

The surface density of group VIB metal, expressed as weight of group VIB oxides per unit area of the catalyst, is between 33×10⁻⁴ and 130×10⁻⁴ g/m², preferably between 37×10⁻⁴ and 120×10−4 g/m², more preferably between 40×10⁻⁴ and 90×10⁻⁴ g/m².

### The Support of the Polishing Hydrodesulfurization Catalyst

The support of the polishing hydrodesulfurization catalyst according to the invention can be in the form of beads, extrudates of any geometry, platelets, pellets, a compressed cylinder, crushed solids or any other shaping. Preferably, the support is in the form of beads with a diameter of 0.5 to 6 mm or in the form of cylindrical, trilobe or quadrilobe extrudates with a circumscribed diameter of 0.8 to 3 mm. More preferentially, the support is in the form of beads.

The support of said catalyst according to the invention comprises alpha-alumina, preferably the support is predominantly composed of alpha-alumina, that is to say it comprises at least 51% by weight of alpha-alumina, preferably at least 60% by weight, very preferably at least 80% by weight, or even at least 90% by weight of alpha-alumina, relative to the total weight of said support. Even more preferentially, the support consists of alpha-alumina.

The specific surface area of the support is greater than or equal to 1 m²/g and less than 20 m²/g, preferably between 1 m²/g and 16 m²/g, and even more preferentially between 5 m²/g and 15 m²/g.

The support advantageously has a total pore volume, measured by mercury porosimetry, of between 0.3 cm³/g and 0.9 cm³/g, preferably between 0.35 cm³/g and 0.8 cm³/g, and very preferably between 0.4 cm³/g and 0.7 cm³/g.

### Preparation of the Polishing Hydrodesulfurization Catalyst

The catalyst according to the invention can be prepared by any technique known to those skilled in the art, and notably by impregnation of the group VIII and VIB metals and phosphorus on the selected porous support. The impregnation can, for example, be carried out according to the method known to those skilled in the art under the terminology of dry impregnation, wherein just the amount of precursors of desired elements in the form of salts soluble in the chosen solvent, for example demineralized water, is introduced so as to fill as exactly as possible the porosity of the support. Preferably, the aqueous impregnation solution, when it contains cobalt, molybdenum and phosphorus, is prepared under pH conditions which promote the formation of heteropolyanions in solution. For example, the pH of such an aqueous solution is between 1 and 5. Preferably, the preparation of the catalyst is carried out without the addition of an organic agent as a mixture with the precursors of the group VIII and group VIB metals and phosphorus.

Use may be made, by way of example, among the sources of molybdenum, of the oxides and hydroxides, molybdic acids and salts thereof, in particular the ammonium salts, such as ammonium molybdate, ammonium heptamolybdate, phosphomolybdic acid (H₃PMo₁₂O₄₀), and salts thereof, and optionally silicomolybdic acid (H₄SiMo₁₂O₄₀) and salts thereof. The sources of molybdenum can also be any heteropolycompound of Keggin, lacunary Keggin, substituted Keggin, Dawson, Anderson or Strandberg type, for example. Use is preferably made of molybdenum trioxide and the heteropolycompounds of Keggin, lacunary Keggin, substituted Keggin and Strandberg type.

The cobalt precursors which can be used are advantageously chosen from the oxides, hydroxides, hydroxycarbonates, carbonates and nitrates, for example. Use is preferably made of cobalt hydroxide and cobalt carbonate.

The phosphorus can advantageously be introduced alone or as a mixture with at least one of the group VIB and VIII metals. The phosphorus is preferably introduced as a mixture with the precursors of the group VIB and group VIII metals by dry impregnation of said porous support using a solution containing the precursors of the metals and the phosphorus precursor. The preferred source of phosphorus is orthophosphoric acid H₃PO₄, but its salts and esters, such as ammonium phosphates or mixtures thereof, are also suitable. The phosphorus can also be introduced at the same time as the group VIB metal(s) in the form, for example, of Keggin, lacunary Keggin, substituted Keggin or Strandberg-type heteropolyanions.

The support thus filled with the solution can be left to mature at a temperature below 50° C., preferably at ambient temperature, for a time not exceeding 12 hours, preferably not exceeding 6 hours.

Following the maturation step, the catalyst precursor obtained can undergo a heat treatment. The aim of this treatment is generally to transform the molecular precursors of the elements into the oxide phase. It is in this case an oxidizing treatment, but a simple drying of the catalyst can also be carried out.

In the case of drying, the catalyst precursor is dried at a temperature of between 50° C. and less than 200° C., preferably between 70° C. and 180° C., for a period typically of between 0.5 hour and 12 hours, and even more preferably for a period of between 0.5 hour and 5 hours.

In the case of an oxidizing treatment, also referred to as calcination, said treatment is generally carried out under air or under dilute oxygen, and the treatment temperature is generally between 200° C. and 550° C., preferably between 300° C. and 500° C., and advantageously for a period typically of between 0.5 hour and 24 hours, preferably for a period from 0.5 hour to 12 hours, and even more preferably for a period from 0.5 hour to 10 hours.

Before it is used as a hydrotreating catalyst, it is advantageous to subject the optionally dried or calcined catalyst to a step of activation by sulfurization. This activation phase is carried out by methods well known to a person skilled in the art, and advantageously under a sulfo-reductive atmosphere in the presence of hydrogen and of hydrogen sulfide. The hydrogen sulfide can be used directly or generated by a sulfide agent (such as dimethyl disulfide).

### Process for the Hydrodesulfurization of Gasoline

Another subject of the invention relates to a process for treating a gasoline containing sulfur compounds and olefins, the process comprising at least the following steps:
a) the gasoline, hydrogen and a hydrodesulfurization catalyst comprising an active phase comprising a group VIB metal and a group Vill metal at least partly in sulfide form, and an oxide support, are brought into contact in a first reaction section at a temperature of between 200° C. and 350° C., at a pressure of between 0.2 MPa and 5 MPa, with an hourly space velocity of between 1 h⁻¹ and 20 h⁻¹ and a ratio of the hydrogen flow rate, expressed in normal m³ per hour, to the flow rate of feedstock to be treated, expressed in m³ per hour under standard conditions, of between 10 Nm³/m³ and 1000 Nm³/m³, in order to obtain a partially desulfurized effluent;
b) without separating the H₂S formed in step a), the partially desulfurized effluent obtained on conclusion of step a), and a polishing hydrodesulfurization catalyst as described above, are brought directly into contact in a second reaction section at a temperature of between 250° C. and 400° C., at a pressure of between 0.2 MPa and 5 MPa, with an hourly space velocity of between 1 h⁻¹ and 20 h⁻¹, in order to obtain a desulfurized effluent.

### Description of the Feedstock

The process according to the invention makes it possible to treat any type of gasoline cut containing sulfur compounds and olefins, alone or as a mixture, such as, for example, a cut resulting from a coking, visbreaking, steam cracking or catalytic cracking (FCC, Fluid Catalytic Cracking) unit. This gasoline can optionally be composed of a significant fraction of gasoline originating from other production processes, such as atmospheric distillation (gasoline resulting from a direct distillation (or straight run gasoline)), or from conversion processes (coking or steam cracked gasoline). Said feedstock preferably consists of a gasoline cut resulting from a catalytic cracking unit.

The feedstock is a gasoline cut containing sulfur compounds and olefins, the boiling point range of which typically extends from the boiling points of the hydrocarbons having 2 or 3 carbon atoms (C2 or C3) up to 260° C., preferably from the boiling points of the hydrocarbons having 2 or 3 carbon atoms (C2 or C3) up to 220° C., more preferably from the boiling points of the hydrocarbons having 5 carbon atoms up to 220° C. The process according to the invention can also treat feedstocks having lower end points than those mentioned above, such as, for example, a C5-180° C. cut.

The sulfur content of the gasoline cuts produced by catalytic cracking (FCC) depends on the sulfur content of the feedstock treated by the FCC, on the presence or absence of a pretreatment of the feedstock of the FCC, as well as on the end point of the cut. Generally, the sulfur contents of the whole of a gasoline cut, in particular those originating from the FCC, are greater than 100 ppm by weight and most of the time greater than 500 ppm by weight. For gasolines having end points of greater than 200° C., the sulfur contents are often greater than 1000 ppm by weight; they can even, in certain cases, reach values of the order of 4000 to 5000 ppm by weight.

The feedstock treated by the process according to the invention can be a feedstock containing sulfur compounds in a content of greater than 200 ppm by weight of sulfur and often of greater than 500 ppm.

In addition, the gasolines resulting from catalytic cracking (FCC) units contain, on average, between 0.5% and 5% by weight of diolefins, between 20% and 50% by weight of olefins and between 10 ppm and 0.5% by weight of sulfur, including generally less than 300 ppm of mercaptans.

### Step a0) Selective Hydrogenation Step (Optional)

Depending on the type of gasoline to be treated, it may be advantageous to treat the gasoline beforehand in the presence of hydrogen and of a selective hydrogenation catalyst so as to at least partially hydrogenate the diolefins and to carry out a reaction for increasing the molecular weight of a portion of the light mercaptans (RSH) present in the feedstock to give thioethers, by reaction with olefins.

To this end, the gasoline to be treated is sent to a selective hydrogenation catalytic reactor containing at least one fixed or moving bed of catalyst for the selective hydrogenation of the diolefins and for increasing the molecular weight of the light mercaptans. The reaction for the selective hydrogenation of the diolefins and for increasing the molecular weight of the light mercaptans is preferentially carried out on a sulfided catalyst comprising at least one group VIII metal and optionally at least one group VIB metal and an oxide support. The group VIII metal is preferably chosen from nickel and cobalt and in particular nickel. The group VIB metal, when it is present, is preferably chosen from molybdenum and tungsten and very preferably molybdenum.

The oxide support of the catalyst is preferably chosen from alumina, nickel aluminate, silica, silicon carbide or a mixture of these oxides. Use is preferably made of alumina and more preferably still of high-purity alumina. According to a preferred embodiment, the selective hydrogenation catalyst contains nickel at a content by weight of nickel oxide, in NiO form, of between 1% and 12%, and molybdenum at a content by weight of molybdenum oxide, in MoO₃ form, of between 6% and 18% and a nickel/molybdenum molar ratio of between 0.3 and 2.5, the metals being deposited on a support consisting of alumina. The degree of sulfidation of the metals constituting the catalyst is preferably greater than 60%.

During the optional selective hydrogenation step, the gasoline is brought into contact with the catalyst at a temperature of between 50° C. and 250° C., preferably between 80° C. and 220° C. and more preferably still between 90° C. and 200° C., with an hourly space velocity (HSV) of between 0.5 h⁻¹ and 20 h⁻¹, the unit of the hourly space velocity being the volume flow rate of feedstock at 15° C. per volume of catalyst bed and per hour (l/l/h). The pressure is between 0.2 and 5 MPa, preferably between 0.6 and 4 MPa and more preferably still between 1 and 3 MPa. The optional selective hydrogenation step is typically carried out with a ratio of the hydrogen flow rate, expressed in normal m³ per hour, to the volume flow rate of feedstock to be treated, expressed in m³ per hour under standard conditions (15° C., 0.1 MPa), of between 2 and 100 Nm³/m³, preferably between 3 and 30 Nm³/m³.

After selective hydrogenation, the content of diolefins, determined via the maleic anhydride value (MAV), according to the UOP 326 method, is generally reduced to less than 6 mg maleic anhydride/g, indeed even less than 4 mg MA/g and more preferably less than 2 mg MA/g. In some cases, less than 1 mg MA/g may be obtained.

The selectively hydrogenated gasoline may then subsequently be distilled into at least two cuts, a light cut and a heavy cut and optionally an intermediate cut. In the case of the fractionation into two cuts, the heavy cut is treated according to the process of the invention. In the case of the fractionation into three cuts, the intermediate and heavy cuts can be treated separately by the process according to the invention.

It should be noted that it is possible to envisage carrying out the steps of hydrogenation of the diolefins and of fractionation into two or three cuts simultaneously by means of a catalytic distillation column which includes a distillation column equipped with at least one catalytic bed.

### Step a) Selective Hydrodesulfurization (HDS) Step

The hydrodesulfurization step a) is implemented in order to reduce the sulfur content of the gasoline to be treated by converting the sulfur compounds into H₂S.

The temperature is generally between 200° C. and 350° C. and preferably between 220° C. and 320° C. The temperature employed must be sufficient to keep the gasoline to be treated in the gas phase in the reactor.

The operating pressure of this step is generally between 0.2 MPa and 5 MPa and preferably of between 1 MPa and 3 MPa.

The amount of catalyst employed in each reactor of the first reaction section is generally such that the ratio of the volume flow rate at 15° C. of gasoline to be treated, expressed in m³ per hour under standard conditions, per m³ of catalyst bed (also called hourly space velocity or HSV) is between 1 and 20 h⁻¹ and preferably between 2 and 10 h⁻¹.

The hydrogen flow rate is generally such that the ratio of the hydrogen flow rate, expressed in normal m³ per hour (Nm³/h), to the volume flow rate of feedstock to be treated, expressed in m³ per hour under standard conditions (15° C., 0.1 MPa), is between 10 and 1000 Nm³/m³, preferably between 50 and 600 Nm³/m³. Normal m³ is understood to mean the volume of 1 m³ of gas at 0° C. and 0.1 MPa.

The hydrogen required for this step can be fresh hydrogen or recycled hydrogen, preferably freed from H₂S, or a mixture of fresh hydrogen and of recycled hydrogen. Preferably, a mixture of fresh hydrogen and recycled hydrogen will be used.

The degree of desulfurization of step a), which depends on the sulfur content of the feedstock to be treated, is generally greater than 50% and preferably greater than 70%, so that the product resulting from step a) contains less than 200 ppm by weight of sulfur and preferably less than 100 ppm by weight of sulfur.

In the process according to the invention, the degree of hydrogenation of the olefins is preferably less than 50%, more preferably less than 40% during this step.

According to the invention, the hydrodesulfurization catalyst of step a) comprises an active phase comprising, preferably consisting of, at least one group VIB metal and at least one group VIII metal, optionally phosphorus, and an oxide support, as described below.

The group VIB metal present in the active phase of the catalyst is preferentially chosen from molybdenum and tungsten.

The group VIII metal present in the active phase of the catalyst is preferentially chosen from cobalt, nickel and the mixture of these two metals.

The active phase of the catalyst is preferably chosen from the group formed by the combination of the metals nickel-molybdenum, cobalt-molybdenum and nickel-cobalt-molybdenum and very preferably the active phase consists of cobalt and molybdenum.

The content of group VIII metal is preferably between 0.1% and 10% by weight of oxide of the group VIII metal, relative to the total weight of the catalyst, more preferentially between 0.6% and 8% by weight, even more preferentially between 0.6% and 7% by weight, and very preferably between 1% and 6% by weight of oxide of the group VIII metal relative to the total weight of the catalyst. When the metal is cobalt or nickel, the metal content is expressed as CoO or NiO.

The content of group VIB metal is preferably between 1% and 20% by weight of oxide of the group VIB metal relative to the total weight of the catalyst, more preferentially between 2% and 18% by weight, and very preferably between 3% and 16% by weight of oxide of the group VIB metal relative to the total weight of the catalyst. When the metal is molybdenum or tungsten, the metal content is expressed as MoO₃ or WO₃.

Preferably, the group VIII metal to group VIB metal molar ratio of the catalyst is generally between 0.1 and 0.8 mol/mol, preferably between 0.2 and 0.6 mol/mol.

Optionally, the catalyst can additionally have a phosphorus content generally of between 0.3% and 10% by weight of P₂O₅ relative to the total weight of catalyst, preferably between 0.3% and 5% by weight, very preferably between 0.5% and 3% by weight.

Furthermore, when phosphorus is present, the phosphorus/(group VIB metal) molar ratio is generally between 0.1 and 0.7 mol/mol, preferably between 0.2 and 0.6 mol/mol.

Preferably, the catalyst of step a) has a specific surface area of between 60 and 250 m²/g, preferably between 60 and 200 m²/g, and even more preferentially between 65 and 180 m²/g, and even more preferably between 70 and 130 m²/g.

The total pore volume of the catalyst of step a) is generally between 0.3 cm³/g and 1.3 cm³/g, preferably of between 0.4 cm³/g and 1.1 cm³/g.

The oxide support of the hydrodesulfurization catalyst is typically a porous solid chosen from the group consisting of: aluminas, silica, silica-alumina or else titanium or magnesium oxides, used alone or as a mixture with alumina or silica-alumina. It is preferably chosen from the group consisting of silica, alumina and silica-alumina. Very preferably, the oxide support essentially consists of alumina, that is to say it comprises at least 51% by weight, preferably at least 60% by weight, very preferably at least 80% by weight, or even at least 90% by weight, of alumina, relative to the total weight of said oxide support. It preferably consists solely of alumina.

In a preferred embodiment, the catalyst of step a) comprises an alumina support and an active phase comprising, preferably consisting of, cobalt and molybdenum, said catalyst containing a content by weight, relative to the total weight of catalyst, of cobalt oxide, in CoO form, of between 0.1% and 10% by weight, preferably between 0.6% and 8% by weight, more preferentially between 0.6% and 7% by weight and even more preferentially between 1% and 6% by weight, and a content by weight, relative to the total weight of catalyst, of molybdenum oxide, in MoO₃ form, of between 1% and 20% by weight, preferably between 2% and 18% by weight, and very preferably between 3% and 16% by weight, with a cobalt/molybdenum molar ratio of between 0.1 and 0.8 mol/mol, preferably between 0.2 and 0.6 mol/mol.

Preferably, the support of the hydrodesulfurization catalyst has a specific surface area of between 60 and 250 m²/g, preferably between 60 and 200 m²/g, and even more preferentially between 65 and 180 m²/g, and even more preferably between 70 and 130 m²/g.

The total pore volume of the support of the hydrodesulfurization catalyst is generally between 0.3 cm³/g and 1.3 cm³/g, preferably between 0.4 cm³/g and 1.1 cm³/g.

The support of the hydrodesulfurization catalyst can be in the form of beads, extrudates of any geometry, platelets, pellets, a compressed cylinder, crushed solids or any other shaping. Preferably, the support is in the form of beads with a diameter of 0.5 to 6 mm or in the form of cylindrical, trilobe or quadrilobe extrudates with a circumscribed diameter of 0.8 to 3 mm. More preferentially, the support is in the form of beads.

The first partially desulfurized effluent obtained on conclusion of step a) is then sent directly and without separation to step b) of the process according to the invention.

### Step b) Polishing Hydrodesulfurization (FNS) Step

During the hydrodesulfurization step a), a large part of the sulfur compounds is converted into H₂S. The remaining sulfur compounds are essentially refractory sulfur compounds and the recombinant mercaptans resulting from the addition of the H₂S formed in step a) to the olefins present in the feedstock.

Step b) of the process according to the invention consists in transforming at least a portion of the recombinant mercaptans contained in the first effluent from step a) into olefins and H₂S and also at least a portion of the sulfur compounds contained in the first effluent from step a), such as thiophene compounds, into saturated compounds, for example into thiophanes (or thiacyclopentanes) or into mercaptans, then in at least partially hydrogenolyzing these sulfur compounds to form H₂S.

Preferably, step b) is carried out at a higher temperature than that of step a). Specifically, by using a higher temperature in this step compared to the temperature of step a), the formation of mercaptans will be disfavored by shifting the thermodynamic equilibrium. Step b) also makes it possible to continue the hydrodesulfurization of the residual sulfur compounds.

The temperature is generally between 250° C. and 400° C., preferably between 270° C. and 390° C. The temperature employed must be sufficient to keep the gasoline to be treated in the gas phase in the reactor.

The operating pressure of this step is generally of between 0.2 MPa and 5 MPa and preferably of between 1.5 MPa and 3 MPa.

The amount of catalyst employed in each reactor is generally such that the ratio of the volume flow rate of gasoline to be treated, expressed in m³ per hour under standard conditions (15° C., 0.1 MPa), per m³ of catalyst bed (hourly space velocity or HSV) is between 1 and 20 h⁻¹ and preferably between 2 and 10 h⁻¹.

The polishing hydrodesulfurization catalyst as described above is used in the polishing hydrodesulfurization step b).

In the process according to the invention, the total degree of hydrogenation of the olefins of step b) is preferably less than 30%, more preferably less than 20%, and very preferably less than 15%, during this step.

The total degree of desulfurization of step b), which depends on the sulfur content of the feedstock to be treated, is generally greater than 50% and preferably greater than 70%, so that the product resulting from step b) contains less than 50 ppm by weight of sulfur and preferably less than 20 ppm by weight of sulfur, and even more preferably less than 10 ppm by weight of sulfur.

### Step c): Step of Separating the H₂S [Optional]

The separation step c) is carried out in order to separate the excess hydrogen and also the H₂S formed during steps a) and b). Any method known to a person skilled in the art can be envisaged.

According to a first embodiment, after steps a) and b), the effluent is cooled to a temperature generally below 80° C. in order to condense the hydrocarbons. The gas and liquid phases are subsequently separated in a separation drum. The liquid fraction, which contains the desulfurized gasoline and also a fraction of dissolved H₂S, is sent to a stabilizer column or debutanizer. This column separates a top cut, consisting essentially of residual H₂S and of hydrocarbon compounds having a boiling point lower than or equal to that of butane, and a bottom cut stripped of H₂S, referred to as stabilized gasoline, containing the compounds having a boiling point greater than that of n-butane.

According to a second embodiment, after the condensation step, the liquid fraction which contains the desulfurized gasoline and also a fraction of dissolved H₂S is sent to a stripping section, while the gaseous fraction, consisting mainly of hydrogen and H₂S, is sent to a purification section. The stripping can be carried out by heating the hydrocarbon fraction, alone or with an injection of hydrogen or steam, in a distillation column in order to extract, at the top, the light compounds which were entrained by dissolution in the liquid fraction and also the dissolved residual H₂S. The temperature of the stripped gasoline recovered at the column bottom is generally between 120° C. and 250° C.

Preferably, the separation step c) is carried out in a stabilizer column or debutanizer. This is because a stabilizer column makes it possible to separate the H₂S more efficiently than a stripping section.

Step c) is preferably carried out in order for the sulfur in the form of H₂S remaining in the desulfurized gasoline to represent less than 30%, preferably less than 20% and more preferably less than 10% of the total sulfur present in the treated hydrocarbon fraction.

### Sulfidation of the Catalysts

Before being brought into contact with the feedstock to be treated in a process for the hydrodesulfurization of gasolines, the catalysts used in the process according to the invention generally undergo a sulfidation step. The sulfidation is preferably carried out in a sulfo-reductive medium, that is to say in the presence of H₂S and of hydrogen, in order to convert the metal oxides to sulfides. The sulfidation is carried out by injecting, onto the catalyst, a stream containing H₂S and hydrogen, or else a sulfur compound capable of decomposing to H₂S in the presence of the catalyst and hydrogen. Polysulfides, such as dimethyl disulfide (DMDS), are H₂S precursors commonly used to sulfide catalysts. The sulfur can also originate from the feedstock. The temperature is adjusted in order for H₂S to react with the metal oxides to form metal sulfides. This sulfidation can be carried out in situ or ex situ (inside or outside the reactor) of the reactor of the process according to the invention at temperatures of between 20° and 600° C. and more preferentially between 30° and 500° C.

The degree of sulfidation of the metals constituting the catalysts is at least equal to 60%, preferably at least equal to 70%. The sulfur content in the sulfided catalyst is measured by elemental analysis according to ASTM D5373. A metal is regarded as sulfided when the overall degree of sulfidation, defined by the molar ratio of the sulfur (S) present on the catalyst to said metal, is at least equal to 60% of the theoretical molar ratio corresponding to the complete sulfidation of the metal(s) under consideration. The overall degree of sulfidation is defined by the following equation:

$${( S / metal )}_{catalyst} \geq 0.6 \times {( S / metal )}_{theoretical}$$

in which:
(S/metal)_{catalyst} is the molar ratio of the sulfur (S) to the metal which are present on the catalyst
(S/metal)_{theoretical} is the molar ratio of the sulfur to the metal corresponding to the complete sulfidation of the metal to give sulfide.

This theoretical molar ratio varies according to the metal under consideration:

$${( S / Co )}_{theoretical} = 1$$

$${( S / Ni )}_{theoretical} = 1$$

$${( S / Mo )}_{theoretical} = 2 / 1$$

$${( S / W )}_{theoretical} = 2 / 1$$

When the catalyst comprises several metals, the molar ratio of the S present on the catalyst to the combined metals also has to be at least equal to 60% of the theoretical molar ratio corresponding to the complete sulfidation of each metal to give sulfide, the calculation being carried out in proportion to the relative molar fractions of each metal.

The examples below illustrate the invention without limiting the scope thereof.

### EXAMPLES

The analytical methods used to characterize the feedstocks and effluents are as follows:
sulfur content according to the ASTM D2622 method for contents above 10 ppm S and the ISO 20846 method for contents below 10 ppm S;
content of mercaptans according to the ASTM D3227 method;
content of olefins based on gas chromatography analysis according to the ASTM D6733 method.

### Example 1: Preparation of Catalyst A (in Accordance with the Invention)

A support A′ is provided, which support is mainly composed of alpha-alumina in the form of beads with a particle size of between 2 and 4 mm, and having a specific surface area of 12 m²/g and a pore volume of 0.51 ml/g.

Cobalt, molybdenum and phosphorus are then added. The impregnation solution is prepared by dissolution, at 100° C., of molybdenum oxide (2.56 g, ≥99.5%, Sigma-Aldrich®), of cobalt hydroxide (0.73 g, 96%, Alfa Aesar®), of phosphoric acid at 85% by weight (0.49 g, 99.99%, Sigma-Aldrich®) in 15 ml of demineralized water. After dry impregnation of 40 g of support A′, the impregnated alumina is left to mature in a water-saturated atmosphere at ambient temperature for 4 hours, and then dried at 120° C. for 4 hours. The catalyst thus obtained is denoted A.

The final element composition of catalyst A, expressed in the form of oxides and relative to the weight of dry catalyst, is then the following: MoO₃=5.9±0.2% by weight, CoO=1.3±0.1% by weight and P₂O₅=0.7±0.1% by weight.

The Co/Mo and P/Mo molar ratios are respectively 0.39 and 0.24.

The specific surface area of catalyst A is 12 m²/g. The surface density of molybdenum is 49.2×10⁻⁴ g_{MoO3}/m².

### Example 2: Preparation of Catalyst B (not in Accordance with the Invention)

A support B′ is provided, which support is mainly composed of gamma-alumina in the form of beads with a particle size of between 2 and 4 mm, and having a specific surface area of 139 m²/g and a pore volume of 0.97 ml/g.

Nickel is then added. The impregnation solution is prepared by dissolving, at ambient temperature, nickel nitrate hexahydrate (34.36 g, ≥99.5%, Sigma-Aldrich®) in 25 ml of demineralized water. After dry impregnation of 40 g of support B′, the impregnated alumina is left to mature in a water-saturated atmosphere for 4 hours at ambient temperature, then dried at 120° C. for 4 hours, and lastly calcined under an air flow of 1 l/h/g at 450° C. for 4 hours. The catalyst thus obtained is denoted B.

The final element composition of catalyst B, expressed in the form of oxides and relative to the weight of dry catalyst, is then the following: NiO=17.9±0.3 wt %.

The specific surface area of catalyst B is 114 m²/g.

### Example 3: Preparation of Catalyst C (not in Accordance with the Invention)

A support C′, identical to support B′, is provided.

Cobalt, molybdenum and phosphorus are then added. The impregnation solution is prepared by dissolution, at 100° C., of molybdenum oxide (4.62 g, ≥99.5%, Sigma-Aldrich®), of cobalt hydroxide (1.19 g, 96%, Alfa Aesar®), of phosphoric acid at 85% by weight (1.05 g, 99.99%, Sigma-Aldrich®) in 28 ml of demineralized water. After dry impregnation of 40 g of support C′, the impregnated alumina is left to mature in a water-saturated atmosphere at ambient temperature for 4 hours, and then dried at 120° C. for 4 hours. The catalyst thus obtained is denoted C.

The final element composition of catalyst C, expressed in the form of oxides and relative to the weight of dry catalyst, is then the following: MoO₃=10.0±0.2 wt %, CoO=2.1±0.1 wt % and P₂O₅=1.4±0.1 wt %.

The Co/Mo and P/Mo molar ratios are respectively 0.42 and 0.29. The specific surface area of catalyst C is 118 m²/g.

The surface density of molybdenum is 8.5×10⁻⁴ g_{MoO3}/m².

### Example 4: Preparation of Catalyst D (not in Accordance with the Invention)

A support D′, identical to support B′, is provided.

Cobalt and molybdenum are then added. The impregnation solution is prepared by dissolving, at ambient temperature, ammonium heptamolybdate tetrahydrate (5.64 g, ≥99.5%, Sigma-Aldrich®) and cobalt nitrate hexahydrate (5.36 g, ≥99.5%, Alfa Aesar®) in 28 ml of demineralized water. After dry impregnation of 40 g of support D′, the impregnated alumina is left to mature in a water-saturated atmosphere for 4 hours at ambient temperature, then dried at 120° C. for 4 hours, and lastly calcined under an air flow of 1 l/h/g at 450° C. for 4 hours. The catalyst thus obtained is denoted D.

The final element composition of catalyst D, expressed in the form of oxides and relative to the weight of dry catalyst, is then the following: MoO₃=10.0±0.2 wt % and CoO=3.0±0.1 wt %. The Co/Mo and P/Mo molar ratios are respectively 0.60 and 0.

The specific surface area of catalyst D is 124 m²/g. The surface density of molybdenum is 8.1×10⁻⁴ g_{MoO3}/m².

### Example 5: Preparation of Catalyst E (not in Accordance with the Invention)

A support E′ is provided, which support is mainly composed of gamma-alumina in the form of beads with a particle size of between 2 and 4 mm, and having a specific surface area of 194 m²/g and a pore volume of 0.60 ml/g.

Cobalt, molybdenum and phosphorus are then added. The impregnation solution is prepared by dissolution, at 100° C., of molybdenum oxide (2.24 g, ≥99.5%, Sigma-Aldrich®), of cobalt hydroxide (0.61 g, 96%, Alfa Aesar®), of phosphoric acid at 85% by weight (0.49 g, 99.99%, Sigma-Aldrich®) in 17 ml of demineralized water. After dry impregnation of 40 g of support E′, the impregnated alumina is left to mature in a water-saturated atmosphere at ambient temperature for 4 hours, and then dried at 120° C. for 4 hours. The catalyst thus obtained is denoted E.

The final element composition of catalyst E, expressed in the form of oxides and relative to the weight of dry catalyst, is then the following: MoO₃=5.2±0.2 wt %, CoO=1.1±0.1 wt % and P₂O₅=0.7±0.1 wt %.

The Co/Mo and P/Mo molar ratios are respectively 0.42 and 0.27. The specific surface area of catalyst E is 189 m²/g.

The surface density of molybdenum is 2.7×10⁻⁴ g_{MoO3}/m².

### Example 6: Preparation of Catalyst F (not in Accordance with the Invention)

A support F′ is provided, which support is mainly composed of delta- and theta-alumina in the form of cylindrical extrudates with a diameter of 1.6 mm, and having a specific surface area of 78 m²/g and a pore volume of 0.84 ml/g.

Cobalt, molybdenum and phosphorus are then added. The impregnation solution is prepared by dissolution, at 100° C., of molybdenum oxide (3.67 g, ≥99.5%, Sigma-Aldrich®), of cobalt hydroxide (0.87 g, 96%, Alfa Aesar®), of phosphoric acid at 85% by weight (0.73 g, 99.99%, Sigma-Aldrich®) in 24 ml of demineralized water. After dry impregnation of 40 g of support F′, the impregnated alumina is left to mature in a water-saturated atmosphere at ambient temperature for 4 hours, and then dried at 120° C. for 4 hours. The catalyst thus obtained is denoted F.

The final element composition of catalyst F, expressed in the form of oxides and relative to the weight of dry catalyst, is then the following: MoO₃=8.2±0.2 wt %, CoO=1.5±0.1 wt % and P₂O₅=1.0±0.1 wt %.

The Co/Mo and P/Mo molar ratios are respectively 0.36 and 0.25. The specific surface area of catalyst F is 75 m²/g.

The surface density of molybdenum is 10.9×10⁻⁴ g_{MoO3}/m².

### Example 7: Use of the Catalysts in a Gasoline Desulfurization Process

Gasoline from a catalytic cracking unit composed of 25% by weight of olefins and 600 ppmS of total sulfur is subjected to a 2-step treatment:
a first step of selective hydrodesulfurization (HDS) in an adiabatic reactor using catalyst D. The operating conditions of the step of one-step hydrodesulfurization of the gasoline feedstock are as follows: HSV=3 h⁻¹, P=2.0 MPa. A stream of pure hydrogen is added to the feedstock at the reactor inlet such that H₂/HC=250 Nm³/m³. The effluent is sent directly to the reactor of the second step;
a second polishing hydrodesulfurization (FNS) step in an adiabatic reactor using catalysts A to F. Only the effluent from the first step is treated in this second step. The operating conditions of the polishing step are as follows: HSV=3 h⁻¹, P=2.0 MPa. The reactor inlet temperature is always set at 35° C. higher than the temperature of the effluent leaving the first selective hydrodesulfurization step.

The inlet temperature into the reactor of the first selective hydrodesulfurization step is set to obtain an effluent containing 10 ppm by weight S of total sulfur (i.e. more than 98% conversion of total sulfur).

Prior to being used, the catalysts employed in the selective (HDS) and polishing (FNS) hydrodesulfurization reactors are sulfided by treatment for 4 hours under a pressure of 3.4 MPa at 350° C., in contact with a feedstock consisting of 2% by weight of sulfur in the form of dimethyl disulfide in n-heptane.

The properties of the catalysts are given in table 1. The performance properties in a gasoline desulfurization process are presented in table 2.

The results illustrate that the use of the catalyst according to the invention in a polishing step of a gasoline hydrodesulfurization process makes it possible to obtain the best performances compared to the use of catalysts known from the prior art, in particular in terms of olefin hydrogenation selectivity for a same sulfur content specification at the outlet of the process.

TABLE 1

| | Catalyst | | | | | |
|---|---|---|---|---|---|---|
| | A (in | B (not in | C (not in | D (not in | E (not in | F (not in |
| | accordance | accordance | accordance | accordance | accordance | accordance |
| | with the | with the | with the | with the | with the | with the |
| | invention) | invention) | invention) | invention) | invention) | invention) |
| % by weight MoO₃ | 5.9 | 0 | 10.0 | 10.0 | 5.2 | 8.2 |
| % by weight CoO | 1.3 | 0 | 2.1 | 3.0 | 1.1 | 1.5 |
| % by weight NiO | 0 | 17.9 | 0 | 0 | 0 | 0 |
| % by weight P₂O₅ | 0.7 | 0 | 1.4 | 0 | 0.7 | 1.0 |
| P/VIB (mol/mol) | 0.24 | — | 0.29 | — | 0.27 | 0.25 |
| VIII/VIB (mol/mol) | 0.39 | — | 0.42 | 0.6 | 0.42 | 0.36 |
| d(VIB) | 49.2 | — | 8.5 | 8.1 | 2.7 | 10.9 |
| (10⁻⁴ g_{M}_{_{IVB}}_{O}_{₃}/m²) | | | | | | |
| Specific surface | 12 | 114 | 118 | 124 | 189 | 75 |
| area (m²/g) | | | | | | |
| Predominant | Alpha | Gamma | Gamma | Gamma | Gamma | Delta and |
| crystalline | | | | | | theta |
| phases of the | | | | | | |
| alumina support | | | | | | |

TABLE 2

| | Catalyst used in the polishing step | | | | | |
|---|---|---|---|---|---|---|
| | A (in | B (not in | C (not in | D (not in | E (not in | F (not in |
| | accordance | accordance | accordance | accordance | accordance | accordance |
| | with the | with the | with the | with the | with the | with the |
| | invention) | invention) | invention) | invention) | invention) | invention) |
| Olefins at inlet of | 25.0 | 25.0 | 25.0 | 25.0 | 25.0 | 25.0 |
| step 1 (% by weight) | | | | | | |
| Olefins at outlet of | 17.9 | 16.5 | 15.8 | 15.6 | 15.3 | 16.2 |
| step 2 (% by weight) | | | | | | |
| Overall olefin | 28.4 | 34.0 | 36.8 | 37.6 | 38.2 | 35.2 |
| hydrogenation (%) | | | | | | |
| Sulfur content at | 600 | 600 | 600 | 600 | 600 | 600 |
| inlet (ppm wt S) | | | | | | |
| Sulfur content at | 10 | 10 | 10 | 10 | 10 | 10 |
| outlet (ppm wt S) | | | | | | |
| Reactor inlet | 243 | 253 | 221 | 220 | 219 | 223 |
| temperature - step 1 | | | | | | |
| (° C.) | | | | | | |
| Reactor outlet | 265 | 289 | 225 | 224 | 222 | 228 |
| temperature - step 1 | | | | | | |
| (° C.) | | | | | | |
| Reactor inlet | 300 | 324 | 260 | 259 | 257 | 263 |
| temperature - step 2 | | | | | | |
| (° C.) | | | | | | |
| Reactor outlet | 310 | 326 | 295 | 294 | 295 | 294 |
| temperature - step 2 | | | | | | |
| (° C.) | | | | | | |

1. A polishing hydrodesulfurization catalyst comprising:
an active phase comprising at least one group VIB metal and at least one group VIII metal, phosphorus, and
a porous support comprising alpha-alumina,
wherein the content of group VIB metal, measured in oxide form, is between 1% and 8% by weight relative to the total weight of the catalyst, the content of group VIII metal, measured in oxide form is being between 0.2% and 5% by weight relative to the total weight of the catalyst, and the content of phosphorus, measured in its P₂O₅ form, is between 0.1% and 3% by weight relative to the total weight of the catalyst, and
wherein said catalyst has a specific surface area of greater than or equal to 1 m²/g and less than 20 m²/g.

2. The catalyst as claimed in claim 1, wherein the molar ratio of the group VIII metal to the group VIB metal is between 0.1 and 2.0 mol/mol.

3. The catalyst as claimed in claim 1, wherein the molar ratio of the phosphorus to the group VIB metal is between 0.1 and 2.0 mol/mol.

4. The catalyst as claimed in claim 1, wherein the specific surface area of the catalyst is between 1 m²/g and 16 m²/g.

5. The catalyst as claimed in claim 1, wherein the surface density of group VIB metal, expressed as the weight of group VIB metal oxides per unit area of the catalyst, is between 33×10⁻⁴ and 130×10⁻⁴ g/m².

6. The catalyst as claimed in claim 1, wherein the group VIII metal is cobalt and the group VIB metal is molybdenum.

7. The catalyst as claimed in claim 1, wherein the support is in the form of beads.

8. The catalyst as claimed in claim 1, wherein the active phase contains molybdenum, cobalt, and phosphorus, and the porous support is an alpha-alumina,
wherein the cobalt content is between 0.5% and 3% by weight, measured in the CoO oxide form, relative to the total weight of the catalyst, the molybdenum content is between 3% and 7% by weight, measured in the MoO₃ oxide form, relative to the total weight of the catalyst, and the phosphorus content is between 0.3% and 1.5% by weight, measured in the P₂O₅ oxide form, relative to the total weight of the catalyst, and
wherein the molar ratio of cobalt to molybdenum is between 0.3 and 1.0 mol/mol, the molar ratio of phosphorus to molybdenum is between 0.2 and 0.5 mol/mol, the surface density of molybdenum, expressed in the MoO₃ oxide form, is between 40×10⁻⁴ and 90×10−4 g/m², and the specific surface area of the catalyst is between 1 and 16 m²/g.

9. A process for treating a gasoline containing sulfur compounds and olefins, the process comprising at least the following steps:
a) bringing into contact the gasoline, hydrogen and a hydrodesulfurization catalyst comprising an active phase comprising a group VIB metal and a group VIII metal at least partly in sulfide form, and an oxide support, in a first reaction section at a temperature of between 200° C. and 350° C., at a pressure of between 0.2 MPa and 5 MPa, with an hourly space velocity of between 1 h⁻¹ and 20 h⁻¹ and a ratio of the hydrogen flow rate, expressed in normal m³ per hour, to the volume flow rate of feedstock to be treated, expressed in m³ per hour under standard conditions, of between 10 Nm³/m³ and 1000 Nm³/m³, in order to obtain a partially desulfurized effluent; and
b) bringing into contact, without separating the H₂S formed in step a), the partially desulfurized effluent obtained on conclusion of step a), and a polishing hydrodesulfurization catalyst as claimed in claim 1, at least partly in sulfide form, in a second reaction section at a temperature of between 250° C. and 400° C., at a pressure of between 0.2 MPa and 5 MPa, and with an hourly space velocity of between 1 h⁻¹ and 20 h⁻¹, in order to obtain a desulfurized effluent.

10. The process as claimed in claim 9, wherein the catalyst of step a) comprises an alumina support and an active phase comprising cobalt and molybdenum, said catalyst containing a content by weight, relative to the total weight of catalyst, of cobalt oxide, in CoO form, of between 0.1% and 10% by weight, and a content by weight, relative to the total weight of catalyst, of molybdenum oxide, in MoO₃ form, of between 1% and 20% by weight, and wherein the catalyst has a cobalt/molybdenum molar ratio of between 0.1 and 0.8 mol/mol.

11. The process as claimed claim 9, wherein the catalyst of step a) has a specific surface area of between 60 and 250 m²/g.

12. The process as claimed in claim 9, wherein the temperature of step b) is higher than the temperature of step a).

13. The process as claimed in claim 9, wherein the gasoline is a catalytic cracking gasoline.
